(19) United States
(12) Patent Application Publication
(10) Pub. No.: US 2019/0227743 A1
(43) Pub. Date: Jul. 25, 2019

(54) IDENTIFYING A READ OPERATION FOR A STORAGE DEVICE BASED ON A WORKLOAD OF A HOST SYSTEM

(71) Applicant: Micron Technology, Inc., Boise, ID (US)

(72) Inventor: Marc Hamilton, Eagle City, ID (US)

(21) Appl. No.: 15/878,315

(22) Filed: Jan. 23, 2018

(51) Int. Cl. G06F 3/06

(52) U.S. Cl. CPC G06F 3/0659; G06F 3/061; G06F 11/1068; G06F 3/0673; G06F 3/0604

(57) ABSTRACT

Read requests from a host system may be received. A determination may be made as to whether the read requests are associated with a deterministic workload. In response to determining that the read requests from the host system are associated with the deterministic workload, an indication may be provided for a memory device to perform a type of read operation based on the deterministic workload that is associated with the read requests.

### TECHNICAL FIELD

The present disclosure generally relates to a storage device, and more specifically, relates to identifying a read operation for a storage device based on a workload of a host system.

### BACKGROUND

A storage device may include one or more memory components that store data. For example, a solid-state drive (SSD) may include memory devices such as non-volatile memory devices. The SSD may further include an SSD controller that may manage each of the memory devices and allocate data to be stored at the memory devices. A host system may utilize the SSD and request data from the SSD. The SSD controller may be used to retrieve data from the corresponding memory devices and return the retrieved data to the host system.

### BRIEF DESCRIPTION OF THE DRAWINGS

The present disclosure will be understood more fully from the detailed description given below and from the accompanying drawings of various implementations of the disclosure.

FIG. 1 illustrates an example computing environment that includes a storage device in accordance with some embodiments of the present disclosure.

FIG. 2 is a block diagram of an example controller of the storage device in accordance with some embodiments.

FIG. 3 is a flow diagram of an example method to identify a read operation to be performed by a memory device based on a workload of a host system in accordance with some embodiments of the present disclosure.

FIG. 4 is a flow diagram of an example method to indicate a read operation to be used by a memory device to retrieve data based on a workload of a host system in accordance with some embodiments of the present disclosure.

FIG. 5A illustrates an example of a deterministic workload in accordance with some embodiments of the present disclosure.

FIG. 5B illustrates an example of a random workload in accordance with some embodiments of the present disclosure.

FIG. 6A illustrates the assertion of word lines and bit lines of a memory device based on a word line ramp read operation in accordance with some embodiments of the present disclosure.

FIG. 6B illustrates the assertion of word lines and bit lines of the memory device based on a discrete read operation in accordance with some embodiments of the present disclosure.

FIG. 7 is a flow diagram of an example method to determine a read operation to be used by a memory device to retrieve data in accordance with some embodiments.

FIG. 8 is a flow diagram of an example method to determine a read operation to be used by a memory device based on an aggregation of read requests from host systems in accordance with some embodiments of the present disclosure.

FIG. 9 is a block diagram of an example computer system in which implementations of the present disclosure may operate.

### DETAILED DESCRIPTION

Aspects of the present disclosure are directed to identifying a read operation for a storage device based on a workload of a host system. In general, a host system may utilize a storage device that includes one or more memory devices. The host system may provide data to be stored at the storage device and may subsequently retrieve data stored at the storage device. The data may be stored and read from the memory devices within the storage device. The workload of the host system may be a group of read requests provided by the host system to retrieve data from the memory devices.

An example of a storage device is a solid-state drive (SSD) that includes non-volatile memory and a controller to manage the non-volatile memory. The controller may identify or indicate an operation to be used by the non-volatile memory to retrieve data that is stored at a particular location of the non-volatile memory. The data stored at the non-volatile memory may be organized at memory pages (i.e., memory cells) that correspond to logical units of the non-volatile memory. Each of the memory pages may be accessed by a word line and a bit line of the non-volatile memory. For example, the controller may provide an operation to assert (e.g., provide a voltage input) at particular word line and a particular bit line to retrieve data stored at a corresponding memory page of the non-volatile memory. As a result, data may be retrieved from memory pages of the non-volatile memory by providing voltage inputs at word lines and bit lines.

The data at the non-volatile memory may be retrieved by using different read operations that are used by the non-volatile memory to read data from within the memory pages of the non-volatile memory. For example, a first type of read operation may be a word line ramp read operation that corresponds to a varying or increasing voltage input that is applied at a word line while different bit lines associated with the word line are also asserted. Such a word line ramp read operation may result in the reading or retrieving of data stored at each memory page that is accessed by the same word line that was asserted and the various different bit lines that were asserted. Thus, the data corresponding to multiple memory pages may be retrieved by using the word line ramp read operation. A second type of read operation may be a discrete read operation that corresponds to asserting the word line by applying a specified voltage input at the word line and asserting a single bit line. Such a discrete read operation may result in the reading or retrieving of data stored at a single memory page (or portion of a page) that is accessed by the word line and the single bit line. Thus, the data corresponding to a single memory page (or portion) may be retrieved by using the discrete read operation.

As such, the use of the word line ramp read operation may result in retrieving data from more memory pages than the discrete read operation, but the word line ramp read operation may take a longer period of time to be performed than a single discrete read operation. However, the use of the word line ramp read operation to retrieve data from each memory page of a particular word line may use less cumulative time than the performance of the discrete read operations to retrieve data from each memory page of the particular word line since the word line may be separately asserted for each instance of a bit line being asserted for each discrete read operation. Thus, if a host system provides a read request for data stored at the non-volatile memory, then a particular read operation of the non-volatile memory may result in the retrieving of data faster than another read operation that is performed by the non-volatile memory. For example, if the host system is providing read requests for deterministic data (e.g., data stored at various memory pages or sequential memory pages on the same word line), then the word line ramp read operation may be used to retrieve the requested data in less time than the discrete read operation for each bit line associated with the word line. Alternatively, if the host system is providing read requests for random data (e.g., for data accessed at different word lines of the non-volatile memory), then the discrete read operation may be used to retrieve the requested data faster than the word line ramp read operation as data from a single memory page (rather than multiple memory pages associated with the word line) may be requested. However, the non-volatile memory may not be aware of the types of read requests being provided by the host system and may thus not perform the word line ramp read operation or the discrete read operation when one of the types of read operations may retrieve requested data in less time.

Aspects of the present disclosure address the above and other deficiencies by identifying a particular read operation for the non-volatile memory device of a solid-state drive to perform based on a workload of the host system. For example, the controller of the solid-state drive may identify whether the workload of the host system is a deterministic workload (e.g., the host system has been requesting data stored at sequential memory pages or memory pages from a group of sequential memory pages) or if the workload of the host system is a random workload (e.g., the host system has been requesting data that is stored at memory pages at random locations or different word lines). If the workload from the host system is a deterministic workload, then the controller may indicate for the non-volatile memory to perform the word line ramp read operation to retrieve data stored at each of the memory pages accessed by a particular word line. Otherwise, if the workload from the host system is a random workload, then the controller may indicate for the non-volatile memory to perform the discrete read operation to retrieve data from particular memory pages accessed by a word line and a particular bit line.

The use of the controller of the solid-state drive to identify a type of read operation to be performed by the non-volatile memory when retrieving data may improve the performance of the solid-state drive. For example, the word line ramp read operation may be used when the workload of the host system is deterministic as the memory pages accessed by a single asserted word line may be subsequently used by the host system. Thus, a single word line ramp read operation may be used to retrieve the memory pages as opposed to multiple discrete read operations to retrieve the memory pages, resulting in the retrieving of the memory pages expected to be used or requested by the host system in less time. Furthermore, the discrete read operation may be used to retrieve a memory page as opposed to the word line ramp read operation when the workload of the host system is random as the data requested by the host system may be accessed by asserting different word lines of the non-volatile memory and memory pages across a single word line may include data that is not expected to be used or requested by the host system. As a result, the read performance of the solid-state drive may be improved as read operations from a host system are performed in less time.

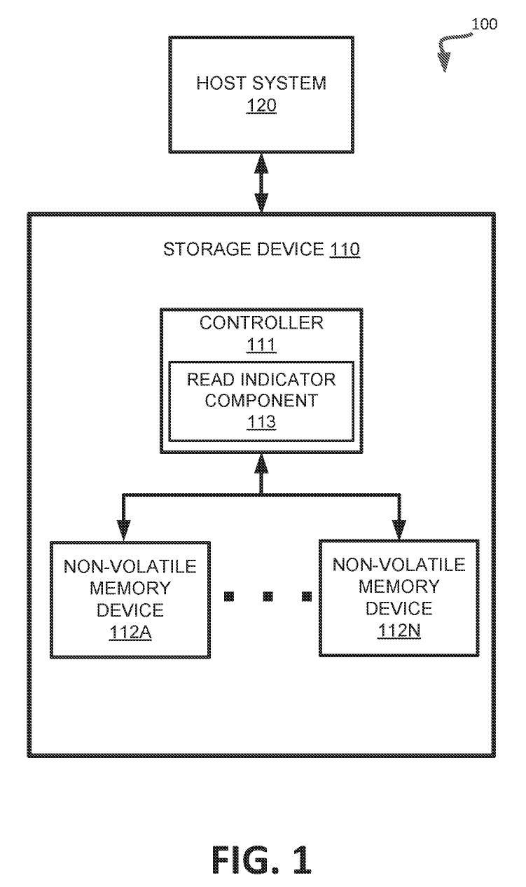

FIG. 1 illustrates an example computing environment 100 that includes a storage device 110. In general, the computing environment 100 may include a host system 120 that uses the storage device 110. For example, the host system 120 may write data to the storage device 110 and read data from the storage device 110.

The host system 120 may be a computing device such as a desktop computer, laptop computer, network server, mobile device, or such computing device that includes a memory and a processing device. The host system 120 may include or be coupled to the storage device 110 so that the host system 120 may read data from or write data to the storage device 110. For example, the host system 120 may be coupled to the storage device 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface may be used to transmit data between the host system 120 and the storage device 110. The host system 120 may further utilize an NVM Express (NVMe) interface to access the memory devices 112A to 112N when the storage device 110 is coupled with the host system 120 by the PCIe interface.

As shown in FIG. 1, the storage device 110 may include a controller 111 and memory devices 112A to 112N. In some embodiments, the memory devices 112A to 112N may be based on non-volatile memory. For example, the memory devices 112A to 112N may be a negative-and (NAND) type flash memory. Each of the memory devices 112A to 112N may include one or more arrays of memory cells such as single level cells (SLCs), multi-level cells (MLCs), or quad-level cells (QLCs). Each of the memory cells may store bits of data (e.g., data blocks) used by the host system 120. Although non-volatile memory devices such as NAND type flash memory are described, the memory devices 112A to 112N may be based on any other type of memory. For example, the memory devices 112A to 112N may be, but are not limited to, random access memory (RAM), read-only memory (ROM), dynamic random access memory (DRAM), synchronous dynamic random access memory (SDRAM), phase change memory (PCM), magneto random access memory (MRAM), negative-or (NOR) flash memory, and electrically erasable programmable read-only memory (EEPROM). Furthermore, the memory cells of the memory devices 112A to 112N may be grouped as memory pages or data blocks that may refer to a unit of the memory device used to store data.

The controller 111 may communicate with the memory devices 112A to 112N to perform operations such as reading data, writing data, or erasing data at the memory devices 112A to 112N and other such operations. The controller 111 may include hardware such as one or more integrated circuits and/or discrete components, software such as firmware or other instructions, or a combination thereof. In general, the controller 111 may receive commands or operations from the host system 120 and may convert the commands or operations into instructions or appropriate commands to achieve the desired access to the memory devices 112A to 112N. The controller 111 may be responsible for other operations such as wear leveling operations, garbage collection operations, error detection and error-correcting code (ECC) operations, encryption operations, caching operations, and address translations between a logical block address and a physical block address that are associated with the memory devices 112A to 112N.

Referring to FIG. 1, the controller 111 may include a read indicator component 113 that may be used to indicate a type of read operation that is to be performed by the memory devices 112A to 112N when retrieving data stored at a respective memory device. For example, the read indicator component 113 may identify a type of workload associated with the host system 120 and may indicate a particular read operation that is to be performed by a corresponding memory device 112A to 112N based on the identified type of workload. For example, the host system 120 may provide a read request for data stored at a particular memory device. The controller 111 may identify the particular memory device 112A to 112N that is storing the requested data and may further identify the type of workload from the host system 120. The controller 111 may subsequently provide an indication to the particular memory device to perform a particular type of read operation within the memory device for the requested data. Further details with regards to the operations of the read indicator component 113 are described below.

The storage device 110 may include additional circuitry or components that are not illustrated. For example, the storage device 110 may include a cache or buffer (e.g., DRAM) and address circuitry (e.g., a row decoder and a column decoder) that may receive an address from the controller 111 and decode the address to access the memory devices 112A to 112N.

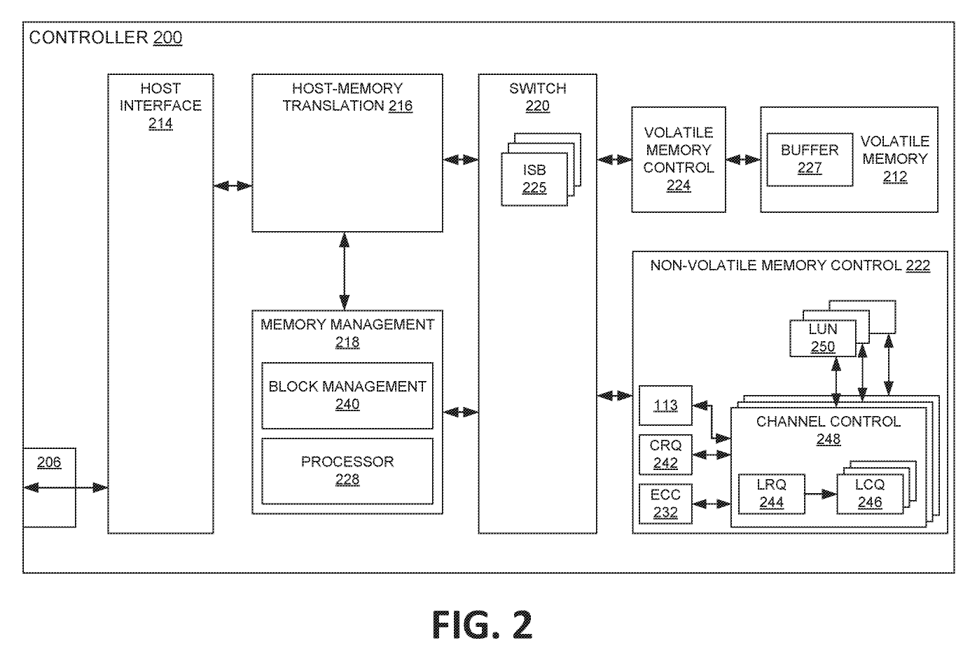

FIG. 2 is a block diagram of an example controller 200 of a storage device. In general, the controller 200 may correspond to the controller 111 of FIG. 1.

As shown in FIG. 2, a non-volatile memory may include a number of memory units 250 and the controller 200 may include a volatile memory 212. A memory unit 250 may be a portion (e.g., a memory page, physical data block, a die of a memory device, etc.) of non-volatile memory that may be independently controllable by the controller 200. The controller 200 may include a host interface circuitry 214 to interface with a host system via a physical host interface 206. The controller may further include host-memory translation circuitry 216, memory management circuitry 218, switch 220, non-volatile memory control circuitry 222, and/or volatile memory control circuitry 224.

The host interface circuitry 214 may be coupled to host-memory translation circuitry 216. The host interface circuitry 214 may interface with a host system. In general, the host interface circuitry 214 may be responsible for converting command packets received from the host system into command instructions for the host-memory translation circuitry 216 and for converting host-memory translation responses into host system commands for transmission to the requesting host system.

Referring to FIG. 2, the host-memory translation circuitry 216 may be coupled to the host interface circuitry 214, to the memory management circuitry 218, and/or to the switch 220. The host-memory translation circuitry 216 may be configured to translate host addresses to memory addresses (e.g., addresses associated with a received command such as a read and/or write command from the host system). For example, the host-memory translation circuitry 216 may convert logical block addresses (LBAs) specified by host system read and write operations to commands directed to specific memory units 250 (e.g., physical block addresses). The host-memory translation circuitry 216 may include error detection/correction circuitry, such as exclusive or (XOR) circuitry that may calculate parity information based on information received from the host interface circuitry 214.

The memory management circuitry 218 may be coupled to the host-memory translation circuitry 216 and the switch 220. The memory management circuitry 218 may control a number of memory operations including, but not limited to, initialization, wear leveling, garbage collection, reclamation, and/or error detection/correction. While the memory management circuitry 218 may include a processor 228, a number of embodiments of the present disclosure provide for control of memory operations in circuitry (e.g., without relying on the execution of instructions such as software and/or firmware) by the processor 228. Memory management circuitry 218 may include block management circuitry 240 to retrieve data from the volatile memory 212 and/or memory units 250 of non-volatile memory. For example, the block management circuitry 240 may retrieve information such as identifications of valid data blocks of the memory units 250, erase counts, and other status information of the memory units 250 to perform memory operations.

The switch 220 may be coupled to the host-memory translation circuitry 216, the memory management circuitry 218, the non-volatile memory control circuitry 222, and/or the volatile memory control circuitry 224. The switch 220 may include and/or be coupled to a number of buffers. For example, the switch 220 may include internal static random access memory (SRAM) buffers (ISBs) 225. The switch may be coupled to DRAM buffers 227 that are included in the volatile memory 212. In some embodiments, the switch 220 may provide an interface between various components of the controller 200. For example, the switch 220 may account for variations in defined signaling protocols that may be associated with different components of the controller 200 in order to provide consistent access and implementation between different components.

The non-volatile memory control circuitry 222 may store information corresponding to a received read command at one of the buffers (e.g., the ISBs 225 or the buffer 227). Furthermore, the non-volatile memory control circuitry 222 may retrieve the information from one of the buffers and write the information to a corresponding memory unit 250 of the non-volatile memory. The number of memory units 250 may be coupled to the non-volatile memory control circuitry 222 by a number of channels. In some embodiments, the number of channels may be controlled collectively by the non-volatile memory control circuitry 222. In some embodiments, each memory channel may be coupled to a discrete channel control circuit 248. A particular channel control circuit 248 may control and be coupled to more than one memory unit 250 by a single channel.

As shown in FIG. 2, the non-volatile memory control circuitry 222 may include a channel request queue (CRQ) 242 that is coupled to each of the channel control circuits 248. Furthermore, each channel control circuit 248 may include a memory unit request queue (RQ) 244 that is coupled to multiple memory unit command queues (CQs) 246. The CRQ 242 may be configured to store commands (e.g., write requests or read requests) shared between channels, the RQ 244 may be configured to store commands between the memory units 250 on a particular channel, and the CQ 246 may be configured to queue a current command and a next command to be executed subsequent to the current command.

The CRQ 242 may be configured to receive a command from the switch 220 and relay the command to one of the RQs 244 (e.g., the RQ 244 associated with the channel that is associated with the particular memory unit 250 for which the command is targeted). The RQ 244 may be configured to relay a first number of commands for a particular memory unit 250 to the CQ 246 that is associated with the particular memory unit 250 in an order that the first number of commands were received by the RQ 244. A command pipeline may structured such that commands to a same memory unit 250 move in a particular order (e.g., in the order that they were received by the RQ 244). The RQ 244 may be configured to queue a command for a particular memory unit 250 in response to the CQ 246 associated with the particular memory unit 250 being full and the CRQ 242 may be configured to queue a command for a particular RQ 244 in response to the particular RQ 244 being full.

The RQ 244 may relay a number of commands for different memory units 250 to the CQs 246 that are associated with the different memory units 250 in an order according to a status of the different memory units 250. For example, the status of the different memory units 250 may be a ready/busy status. The command pipeline is structured such that the commands between different memory units 250 may move out of order (e.g., in an order that is different from the order in which they were received by the RQ 244 according to what is efficient for overall memory operation at the time). For example, the RQ 244 may be configured to relay a first one of the second number of commands to a first CQ 246 before relaying a second command from the second number of commands to a second CQ 246 in response to the status of the different memory unit 250 associated with the second CQ 246 being busy, where the first command is received later in time than the second command. The RQ 244 may be configured to relay the second command to the second CQ 246 in response to the status of the memory unit 250 associated with the second CQ 246 being ready (e.g., subsequent to relaying the first command).

In some embodiments, the control circuits for each channel may include discrete error detection/correction circuitry 232 (e.g., error correction code (ECC) circuitry), coupled to each channel control circuit 248 and/or a number of error detection/correction circuits 232 that can be used with more than one channel. The error detection/correction circuitry 232 may be configured to apply error correction such as Bose-Chaudhuri-Hocquenghem (BCH) error correction to detect and/or correct errors associated with information stored in the memory units 250. The error detection/correction circuitry 232 may be configured to provide differing error correction schemes for SLC, MLC, or QLC operations. The non-volatile memory control circuitry 222 may further include the read indicator component 113 of FIG. 1 to indicate a particular type of read operation that is to be performed by a particular memory device corresponding to one of the memory units 250. Although the read indicator component 113 is illustrated within the non-volatile memory control circuitry 222, the functionality of the read indicator component 113 may be implemented at another location within the controller 200 (e.g., the processor 228).

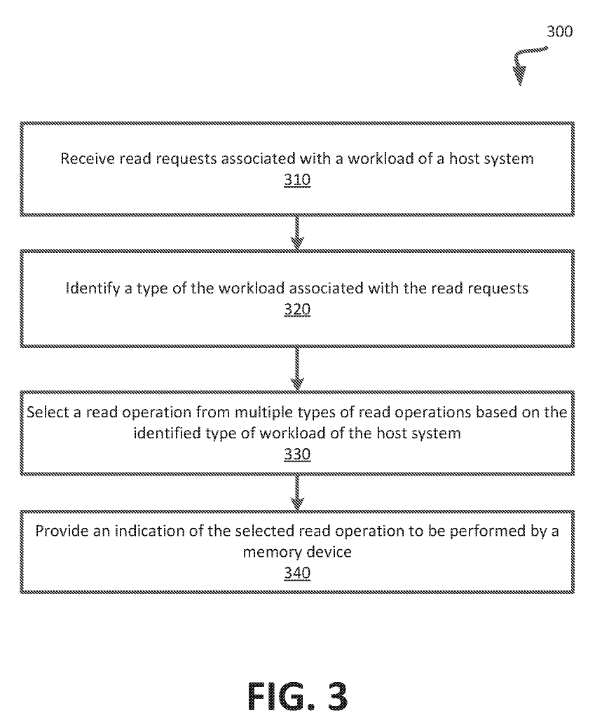

FIG. 3 is a flow diagram of an example method 300 to identify a read operation that is to be performed by a memory device based on a workload of a host system. The method 300 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 may be performed by the read indicator component 113 of the controller 111 of FIG. 1.

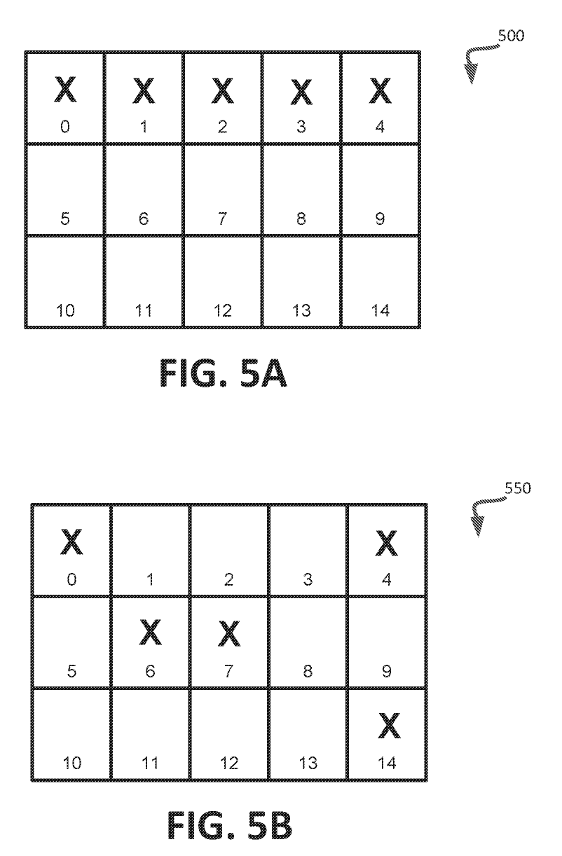

As shown in FIG. 3, the method 300 may begin, at block 310, with processing logic receiving read requests associated with a workload of a host system. The read requests may be received from an application of the host system and may be to retrieve or read data stored at a storage device that is used by the host system. In some embodiments, each of the read requests may identify a logical block address (LBA) that may be used to specify a location of the requested data at the storage device. The processing logic may further identify a type of the workload associated with the read requests that have been received from the host system (block 320). In some embodiments, the workload may be identified after a threshold number of read requests have been received from the host system. The workload may be identified as a deterministic workload or a random workload. A deterministic workload may correspond to read requests for data stored at the storage device that are grouped together. For example, the deterministic workload may be identified when the logical block addresses of consecutively received read requests from the host system are incremented (e.g., an LBA from a read request precedes a subsequent LBA from a subsequent read request). Thus, the deterministic workload may be identified when a group of sequential read requests are received. In the same or alternative embodiments, the deterministic workload may be identified when the logical block addresses of the received read requests are each part of a group of sequential logical block addresses (e.g., the LBA from a first read request is within a group of LBAs and a subsequent LBA from a subsequent read request is within the same group of LBAs). The random workload may be identified when the logical block addresses of consecutively received read requests from the host system are not incremented (e.g., an LBA from a read request does not precede a subsequent LBA from a subsequent read request). Further details with regards to identifying a deterministic workload and a random workload are described in conjunction with FIGS. 5A and 5B.

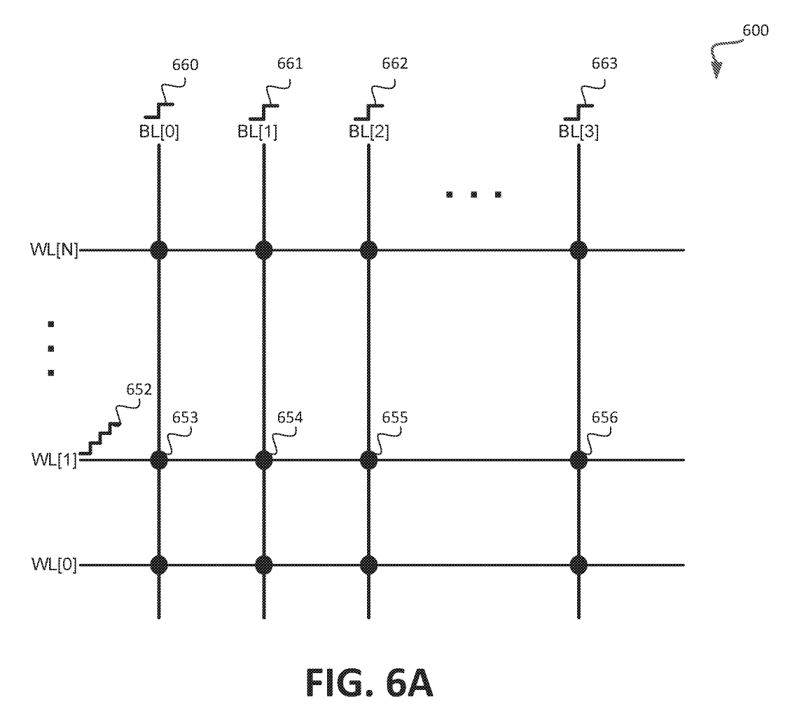

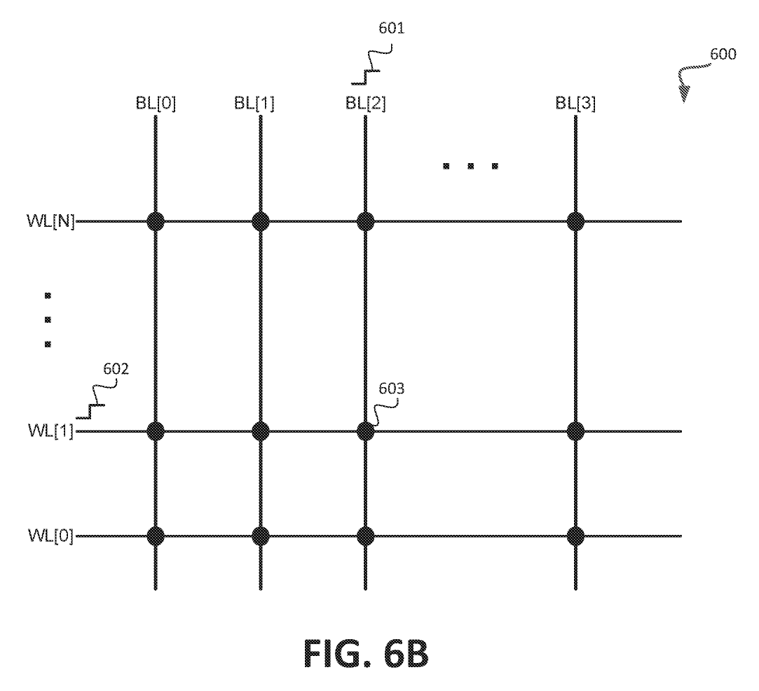

The processing logic may further select a read operation from multiple types of read operations based on the identified type of workload of the host system (block 330). The types of read operations may be operations that a memory device (e.g., a NAND flash memory device) may perform to retrieve data at memory pages of the memory device. Thus, the type of read operation may be an operation that is performed internally within one of the memory devices. One type of read operation may be a discrete read operation that retrieves data associated with a word line and a bit line of the memory device. Another type of read operation may be a word line ramp read operation that retrieves data associated with a word line and multiple bit lines of the memory device. In some embodiments, the discrete read operation may be used by the memory device when the workload of the host system is identified as a random workload and the word line ramp read operation may be used by the memory device when the workload of the host system is identified as a deterministic workload. Furthermore, the processing device may provide an indication of the selected read operation to be performed by a memory device (block 340). The indication provided to the memory device may be an operation code (opcode) that is an instruction that specifies the type of read operation to be performed by the memory device. Thus, a memory device that is storing data requested by the host system may use the specified read operation when retrieving data from memory pages of the memory device. Further details with regards to the types of read operations that may be performed by the memory device are described in conjunction with FIGS. 6A and 6B.

As such, a controller of a storage device (e.g., a solid-state drive) may identify a workload of a host system. If the workload is deterministic, then the controller may indicate to a memory device to retrieve data stored at multiple memory pages by using a word line ramp read operation. Otherwise, if the workload is random, then the controller may indicate to the memory device to retrieve data stored at a memory page by using the discrete read operation. In some embodiments, after the workload has been identified as being deterministic or random, the identification of the workload may be stored at a controller coupled with the memory device. The stored identification may be used by the controller to provide an indication (e.g., opcode) for the memory device to perform a particular type of read operation for subsequently received read requests.

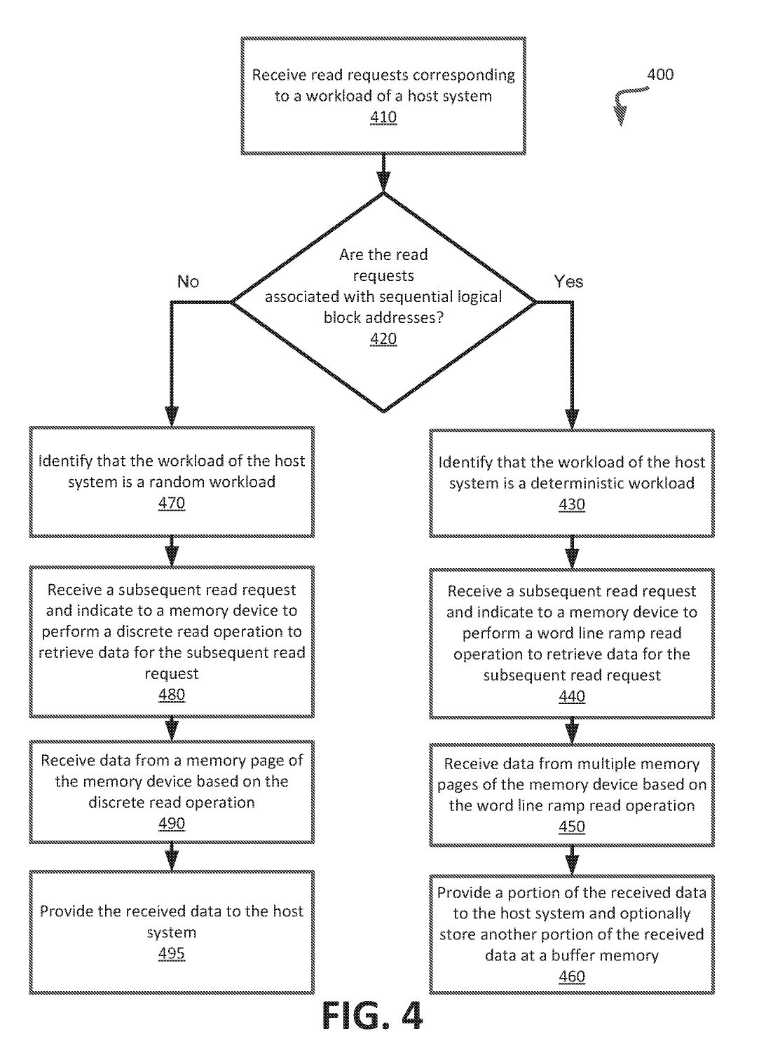

FIG. 4 is a flow diagram of an example method 400 to identify a read operation to be used by a memory device to retrieve data based on a workload of a host system. The method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 may be performed by the read indicator component 113 of the controller 111 of FIG. 1.

As shown in FIG. 4, the method 400 may begin, at block 410, with processing logic receiving read requests corresponding to a workload of a host system. The processing logic may further determine whether the read requests are associated with sequential logical block addresses (block 420). The read requests may be considered to be deterministic when the read requests are associated with sequential logical block addresses. For example, each read request may be a request for retrieving data at a numerical logical block address that maps to a particular portion (e.g., a physical block address) of a particular memory device that is included in a storage device. The logical block addresses may be considered to be sequential when the corresponding logical block address of each read request is incremented from a prior logical block address of a prior read request. If the logical block addresses are incremental, then the underlying data associated with each of the read requests may be stored at consecutive or adjacent portions (e.g., consecutive physical block addresses) of a particular memory device. In some embodiments, the read requests may be considered to be associated with sequential logical block addresses when a threshold number of the logical block addresses of the read requests are within a particular range of logical block addresses (e.g., a group of sequential logical block addresses). For example, 100 read requests for data stored at 100 logical block addresses may be received and if 90 of the 100 read requests specify logical block addresses that are within a range of 100 consecutive logical block addresses, then the workload associated with the 100 read requests may be considered to be deterministic, and thus, the read requests may be considered to be associated with sequential logical block addresses. Otherwise, the workload may be considered to be random if less than the threshold (e.g., 90 read requests) of the read requests specify logical block addresses that are within the range of 100 consecutive logical block addresses. Thus, a deterministic workload may be identified when the logical block addresses of the read requests correspond to sequential logical block addresses. For example, the deterministic workload may be identified when each subsequent logical block addresses is incremented from the prior logical block address of a prior read request or each logical block address of the read requests is within a group of sequential logical block addresses. In some embodiments, the data from the read requests that are used to identify whether the workload is deterministic may be returned to the host system. In the same or alternative embodiments, such data may be retrieved by a memory device using a read operation specified by a controller. For example, the read operation may be the discrete read operation or the word line ramp read operation that is specified by the controller based on a prior workload received from the host system.

In response to determining that the read requests are associated with sequential logical block addresses, then the processing logic may identify that the workload of the host system is a deterministic workload (block 430). Furthermore, the processing logic may receive a subsequent read request and indicate to a memory device to perform a word line ramp read operation to retrieve data for the subsequent read request (block 440). For example, an opcode specifying the word line ramp read operation may be provided to the memory device to retrieve the data for the subsequent read request. When performed, the word line ramp read operation may apply an increasing voltage input to a word line to read data of multiple memory pages associated with multiple bit lines of the memory device as described in conjunction with FIG. 6B. The processing logic may further receive data from multiple memory pages of the memory device based on the word line ramp read operation (block 450). For example, data from multiple memory pages across the word line may be received (e.g., memory pages associated with each bit line across the word line). The data from the multiple memory pages may include data for the received subsequent read request as well as additional data that may be requested by other read requests that are received at a later time. Subsequently, the processing logic may provide a portion of the received data to the host system and optionally store another portion of the received data at a buffer memory (block 460). For example, the provided portion of the received data may be from a memory page of a logical block address identified by the subsequent read request and the other portion of the received data may be from other memory pages that are at logical block addresses that are not identified by the subsequent read request. The other portion of the received data may be stored at the buffer memory of the controller or storage device for subsequent transmission to the host system in response to later read requests from the host system that identify the corresponding logical block addresses. As such, a portion of the data from the multiple memory pages may be returned to the host system when a read request for the portion of the data has previously been received and another portion of the data may be stored at the buffer memory until a subsequent read request for the other portion of the data has been received from the host system. Thus, the data from the multiple memory pages may include data that is currently associated with a received read request and data that is associated with an expected subsequent read request.

Referring to FIG. 4, in response to determining that the read requests are not associated with sequential logical block addresses (block 420), then the processing logic may identify that the workload of the host system is a random workload (block 470). The processing logic may subsequently receive a subsequent read request and indicate for the memory device to perform a discrete read operation to retrieve data for the subsequent read request (block 480). For example, another opcode specifying the discrete read operation may be provided to the memory device. When executed, the discrete read operation may apply a constant voltage input to a word line to read data of one or more memory pages associated with a single bit line of the memory device as described in conjunction with FIG. 6A. The processing logic may further receive data from a memory page of the memory device based on the discrete read operation (block 490). For example, data from one or more memory pages accessed by a single bit line and the word line may be received. Subsequently, the processing logic may provide the received data to the host system (block 495). For example, the data may be returned to the host system in response to the subsequent read request.

In some embodiments, the data received from the discrete read operation may be stored at the buffer memory before being provided to the host system. In some embodiments, the discrete read operation may return less data from the memory device than the word line ramp read operation. As a result, the discrete read operation may result in less data being stored at the buffer memory than when the word line ramp read operation is performed by a memory device of a storage device.

FIG. 5A illustrates an example of a deterministic workload 500. In some embodiments, the deterministic workload 500 may be identified by the read indicator component 113 of the controller 111 of FIG. 1. A workload may correspond to a group of read requests provided by a host system.

As shown in FIG. 5A, logical block addresses zero through fourteen may correspond or be mapped to physical block addresses of a particular memory device. In some embodiments, a logical block address with a value numerically adjacent to the value of another logical block address may result in data of the logical block address being physically adjacent to the data of the other logical block address (e.g., the data are located at adjacent physical block addresses). The read requests from a host system may specify the retrieval of data stored at logical block addresses zero through four as illustrated with an ‘X.’ In some embodiments, the read requests may be consecutively received from the host system. In the same or alternative embodiments, each read request may specify either a single logical block address or multiple logical block addresses. As such, since the logical block addresses of the read requests are numerically adjacent or within a range of a group of sequential logical block addresses (e.g., ‘0’ through ‘4’), then the read requests from the host system may be identified as a deterministic workload. In some embodiments, the read requests of the deterministic workload may identify logical block addresses that are mapped to physical block addresses associated with a single word line of a memory device.

FIG. 5B illustrates an example of a random workload 550. In some embodiments, the random workload 550 may be identified by the read indicator component 113 of the controller 111 of FIG. 1.

As shown in FIG. 5B, the read requests from the host system may identify logical block addresses zero, four, six, seven, and fourteen. As such, since the logical block addresses of the read requests are not incremental or numerically adjacent to the other requested logical block address, then the read requests from the host system may be identified as a random workload. In some embodiments, the read requests may identify logical block addresses that are mapped to physical block addresses associated with different word lines of the memory device.

In some embodiments, the workload from the host system may be identified as having changed from a deterministic workload to a random workload (or vice versa). The workload of the host system may be identified for groups of consecutively received read requests from the host system. For example, a first group of read requests may include a threshold number of read requests. The workload of the host system may be identified based on the logical block addresses of the read requests from the first group. Subsequently, a second group of read requests may be received from the host system. The second group of read requests may include the threshold number of read requests and the read requests may be consecutively received. The workload of the host system may then be identified based on the logical block addresses of the read requests from the second group. If the identified workload is different between the first group of read requests and the second group of read requests, then the type of read operation that is performed for subsequently received read requests may be changed. The identification of the workload may continue for subsequent groups of read requests so that the identified workload may change between a deterministic workload and a random workload as subsequent groups of read requests are received, resulting in the change between performing a word line ramp read operation and a discrete read operation by a memory device.

Although FIGS. 5A and 5B illustrate fifteen logical blocks, any number of logical block addresses may be assigned to a memory device.

FIG. 6A illustrates the assertion of word lines and bit lines of a memory device 600 based on a word line ramp read operation. In some embodiments, the assertion of the word lines and bit lines may be based on an indication to the memory device 600 from the read indicator component 113 of the controller 111 of FIG. 1.

As shown in FIG. 6A, the memory device 600 may include multiple word lines (e.g., word lines ‘0’ to ‘N’) and multiple bit lines (e.g., bit lines ‘0’ to ‘N’). The intersection of a word line and a bit line may correspond to a memory cell or a memory page at a corresponding physical block address. For example, the intersections 653, 654, 655, and 656 between the word line ‘1’ and the bit lines ‘0’ through ‘N’ may correspond to different memory pages at different physical block addresses of a memory device. To retrieve data at a memory page located at an intersection, a voltage input may be provided to a corresponding bit line and a corresponding word line. For example, in the word line ramp read operation, a ramp voltage signal 652 (i.e., a ramped input voltage signal) may be applied to the input of the word line ‘1’ to retrieve the data at the memory pages located at the intersections 653, 654, 655, and 656. In some embodiments, the ramp voltage signal 652 may be increased over a period of time until the data at the memory pages at the intersections 653, 654, 655, and 656 is retrieved. For example, while the ramp voltage signal 652 is provided, a voltage signal 660 may be asserted on the input of the bit line ‘0’ to retrieve the data stored at the memory page located at the intersection 653. Similarly, additional voltage signals 661, 662, and 663 may be asserted on the inputs of the bit lines ‘1’ through ‘N’ to retrieve the data stored at the memory pages located at the intersections 654, 655, and 656. In some embodiments, the voltage signals may be asserted on the inputs of the bit lines as the ramp voltage signal 652 is increased. In some embodiments, the ramp voltage signal 652 may be linearly increased over time. For example, the ramp voltage signal 652 may be at a first voltage level and the voltage signal 660 may be asserted to retrieve the data at the memory page located at the intersection 653. Subsequently, the ramp voltage signal 652 may be increased to a higher second voltage level and the voltage signal 661 may be asserted to retrieve the data at the memory page located at the intersection 654. Similarly, the additional voltage signals 662 and 663 may each be asserted on a bit line as the ramp voltage signal 652 is increased. As such, the word line ramp read operation may be used to retrieve the data stored at memory pages across each of the bit lines that intersects with the word line being asserted with the ramp voltage signal 652.

FIG. 6B illustrates the assertion of word lines and bit lines of the memory device 600 based on a discrete read operation. In some embodiments, the assertion of the word lines and bit lines may be based on an indication to the memory device 600 from the read indicator component 113 of the controller 111 of FIG. 1.

As shown in FIG. 6B, a voltage signal 601 may be asserted on the bit line ‘2’ and another voltage signal 602 may be asserted on the word line ‘1’ to retrieve the data at the memory page located at the intersection 603. In some embodiments, the voltage signal 602 that is asserted on the input of the word line ‘1’ may be held at a constant level and may not be increased over a period of time. Thus, the discrete read operation may be performed by the memory device to read data at a single memory page corresponding to an intersection of a word line and a single bit line. As a result, less data stored at the memory pages across the bit lines that intersect the word line is retrieved as compared to the word line ramp read operation when a constant input voltage signal is asserted.

Thus, the different read operations performed by a memory device based on an indication may correspond to different input voltage signals that are applied to an input (e.g., a word line) of the memory device. Although FIGS. 6A and 6B describe a word line ramp read operation and a discrete read operation, aspects of the present disclosure are not limited to these read operations. For example, aspects of the present disclosure may be used to determine whether to use any other such operations that are used to read data at memory pages of a memory device. For example, other combinations of asserting a voltage input to a word line and/or a bit line may be used with the present disclosure.

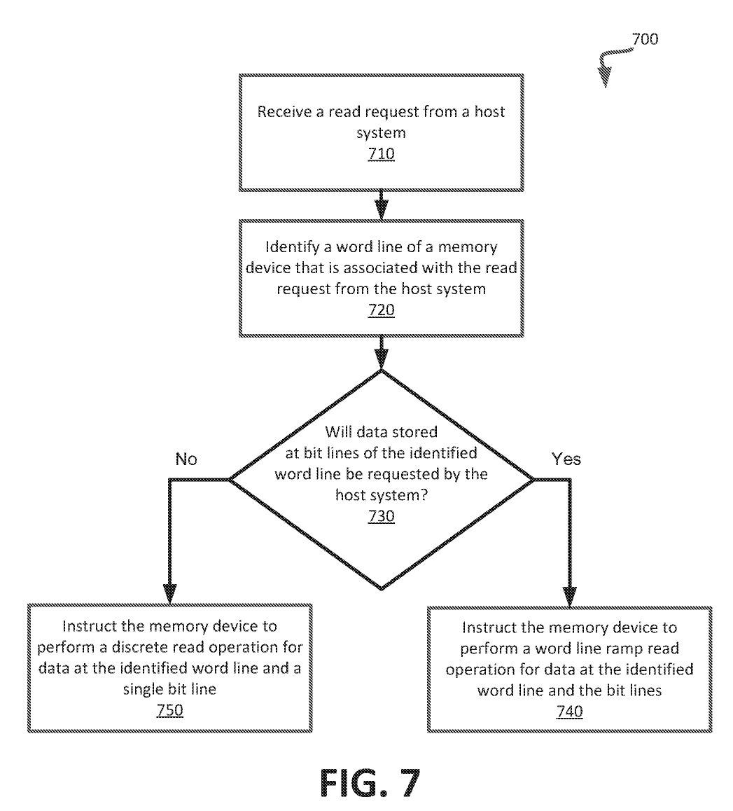

FIG. 7 is a flow diagram of an example method 700 to determine a read operation used by a memory device to retrieve data. The method 700 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 may be performed by the read indicator component 113 of the controller 111 of FIG. 1.

As shown in FIG. 7, the method 700 may begin, at block 710, with the processing logic receiving a read request from a host system. Subsequently, the processing logic may identify a word line of a memory device that is associated with the read request from the host system (block 720). For example, a logical block address of the read request may be mapped to a physical block address of the memory device that corresponds to an intersection of a word line and a bit line of the memory device. The word line is identified from the intersection. The processing logic may subsequently determine whether data stored at bit lines of the identified word line will be requested by the host system (block 730). For example, a determination may be made as to whether a workload associated with the host system is deterministic as previously described. A deterministic workload may utilize and provide read requests for each or a majority of the memory pages located across the word line and each of the bit lines that intersect the word line. In some embodiments, the deterministic workload may utilize data at a threshold number of the memory pages or bit lines that intersect with the word line. A random workload may utilize and provide a request for one or a fewer number of memory pages located across the word line. In response to determining that the data stored at the bit lines of the identified word line will be requested by the host system (e.g., the workload is deterministic), the processing logic may instruct a memory device to perform a word line ramp read operation for the memory pages at the identified word line and the bit lines (block 740). For example, the word line ramp read operation may be used to retrieve data stored at the identified word line and the bit lines that intersect the identified word line. Otherwise, in response to determining that the data stored at the bit lines of the identified word line will not be requested by the host system (e.g., the workload is random), the processing logic may instruct the memory device to perform a discrete read operation for a memory page at the identified word line and a single bit line intersecting the word line (block 750).

Although identifying a workload of a host system as deterministic or random is described to determine whether to indicate for a memory device to perform a word line ramp read operation or a discrete read operation, any other characteristics associated with the host system or the workload of the host system may be used to determine which type of read operation to select to be performed by a memory device. Examples of such characteristics include, but are not limited to, an identification of an application providing the read requests associated with the workload, an identification of a client system providing the read requests, etc. For example, a first identified application may be used to specify that each read request should be performed using the word line ramp read operation, a second identified application may be used to specify that each read request should be performed using the discrete read operation, and a third identified application may specify that each read request should be identified as being either a deterministic workload or a random workload as previously described.

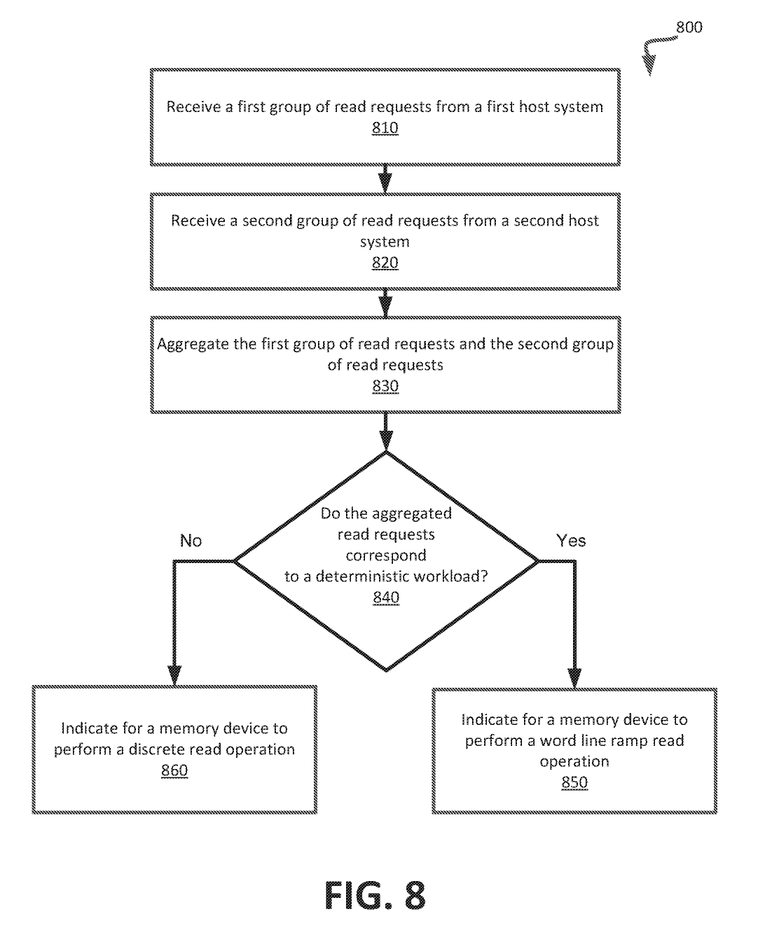

FIG. 8 is a flow diagram of an example method 800 to determine a read operation used by a memory device based on an aggregation of read requests from host systems. The method 800 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 800 may be performed by the read indicator component 113 of the controller 111 of FIG. 1.

As shown in FIG. 8, the method 800 may begin, at block 810, with the processing logic receiving a first group of read requests from a first host system. The processing logic may further receive a second group of read requests from a second host system (block 820). For example, different groups of read requests may be received from different host systems. In some embodiments, the first host system and the second host system may be associated with a same entity (e.g., a same client, user, or other such entity) or a same physical location (e.g., a same data center) or same region. The processing logic may subsequently aggregate the first group of read requests and the second group of read requests (block 830). For example, the aggregation of the read requests from the first and second groups may result in an identification of the logical block addresses of the read requests from the different host systems when the different host systems are associated with the same entity or the same physical location. In some embodiments, the different host systems may be running related applications providing the read requests. For example, the first host system may be providing a first part of a distributed application and the second host system may provide a second part of the distributed application. As a result, the read requests from the first host system and the second host system may be aggregated as the read requests are associated with the same distributed application.

Referring to FIG. 8, the processing logic may determine whether the aggregated read requests correspond to a deterministic workload (block 840). For example, the logical block addresses of the first and second groups may be combined to determine whether the values of the logical block address of the aggregated read requests are incremental or within a range of sequential logical block addresses. In response to determining that the aggregated read requests correspond to the deterministic workload, then the processing logic may indicate for a memory device to perform a word line ramp read operation (block 850). For example, data may be retrieved by the memory device using the word line ramp read operation and the data may subsequently be returned to the first host system and the second host system. Otherwise, in response to determining that the aggregated read requests do not correspond to the deterministic workload, then the processing device may perform a discrete read operation (block 860). For example, the data for each of the read requests may be retrieved by the memory device using the discrete read operation.

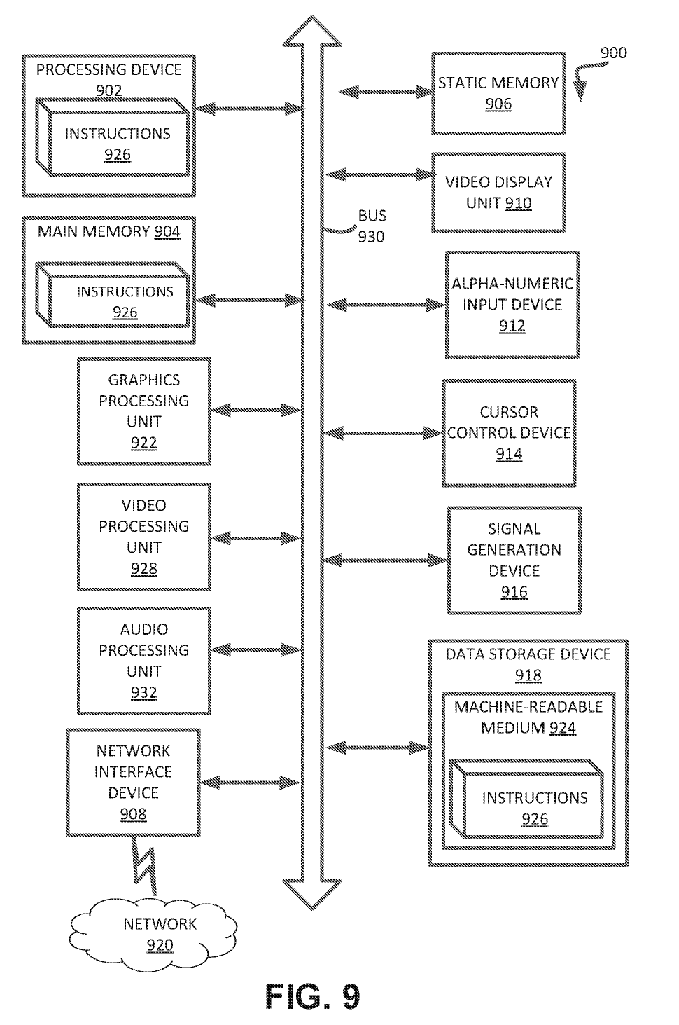

FIG. 9 illustrates an example machine of a computer system 900 within which a set of instructions, for causing the machine to perform any one or more of the methodologies discussed herein, may be executed. For example, the computer system 900 may include or utilize a storage device (e.g., the storage device 110 of FIG. 1) or may be used to perform the operations of a controller (e.g., to execute an operating system to perform operations corresponding to the read indicator component 113 of FIG. 1). In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 930.

Processing device 902 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computer system 900 may further include a network interface device 908 to communicate over the network 920. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable storage medium 924 (also known as a computer-readable medium) on which is stored one or more sets of instructions or software 926 embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media. The machine-readable storage medium 924, data storage device 918, and/or main memory 904 may correspond to the storage device 110 of FIG. 1.

In one implementation, the instructions 926 include instructions to implement functionality corresponding to a read indicator component (e.g., read indicator component 113 of FIG. 1). While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving” or “determining” or “providing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method comprising:
receiving a plurality of read requests from a host system;
determining whether the plurality of read requests are associated with a deterministic workload; and
in response to determining that the plurality of read requests from the host system are associated with the deterministic workload, providing, by a processing device, an indication for a memory device to perform a type of read operation based on the deterministic workload.

2. The method of claim 1, further comprising:
in response to determining that the plurality of read requests from the host system are not associated with the deterministic workload, providing an indication for a memory device to perform a second type of read operation based on a random workload, wherein the type of read operation is different than the second type of read operation.

3. The method of claim 2, wherein the type of read operation that is based on the deterministic workload corresponds to applying a ramped input voltage signal to a word line of the memory device, and wherein the second type of read operation that is based on the random workload corresponds to applying a constant input voltage signal to the word line of the memory device.

4. The method of claim 3, wherein the ramped input voltage signal corresponds to an increasing input voltage that is applied to the word line of the memory device, and wherein the type of read operation that is based on the deterministic workload corresponds to applying a voltage signal to inputs of bit lines of the memory device as the ramped input voltage signal is increased.

5. The method of claim 1, wherein determining whether the plurality of read requests are associated with the deterministic workload comprises:
determining whether the plurality of read requests correspond to sequential block addresses of the memory device; and
identifying the plurality of read requests as being associated with the deterministic workload responsive to the plurality of read requests corresponding to the sequential block addresses of the memory device.

6. The method of claim 1, wherein the type of read operation that is based on the deterministic workload is associated with retrieving data at a plurality of bit lines of the memory device that intersect with a word line of the memory device.

7. The method of claim 1, wherein the memory device is a non-volatile memory of a solid-state drive.

8. A system comprising:
a memory device; and
a controller, operatively coupled with the memory device, to:
receive a read request from a host system;
identify a word line of the memory device that is associated with the read request;
determine whether data associated with a plurality of bit lines of the memory device that intersect the word line of the memory device are associated with a workload corresponding to the read request from the host system; and
in response to determining that the data associated with the plurality of bit lines that intersect the word line are associated with the workload, provide an indication for the memory device to retrieve data corresponding to the read request by using a read operation to retrieve data corresponding to each of the bit lines that intersect the word line.

9. The system of claim 8, wherein the controller is further to:
in response to determining that the data associated with the plurality of bit lines that intersect the word line are not associated with the workload, provide an indication for the memory device to retrieve data corresponding to the read request by using another read operation to retrieve data corresponding to a single bit line that intersects the word line.

10. The system of claim 9, wherein the read operation to retrieve data corresponding to each of the bit lines that intersect the word line corresponds to applying a ramped input voltage signal to the word line of the memory device, and wherein the another read operation to retrieve data corresponding to the single bit line that intersects the word line corresponds to applying a constant input voltage signal to the word line of the memory device.

11. The system of claim 10, wherein the ramped input voltage signal corresponds to an increasing input voltage that is applied to the word line of the memory device.

12. The system of claim 8, wherein to determine whether the data associated with the plurality of bit lines of the memory device that intersect the word line of the memory device are associated with the workload of the host system, the controller is further to:
determine whether subsequent read requests from the host system are associated with sequential block addresses of the memory device; and
identify the workload as being a deterministic workload in response to determining that the subsequent read requests from the host system are associated with the sequential block addresses of the memory device.

13. The system of claim 12, wherein the sequential block addresses of the memory device correspond to each of the bit lines that intersect with the word line.

14. The system of claim 8, wherein the memory device is a non-volatile memory of a solid-state drive.

15. A method comprising:
receiving a read request from a host system;
identifying a characteristic of the host system;
identifying a read operation from a plurality of read operations based on the identified characteristic of the host system; and
providing, by a processing device, the identified read operation to a memory device to retrieve data corresponding to the read request from the memory device.

16. The method of claim 15, wherein the characteristic of the host system is an identification of a workload of the host system being a deterministic workload or a random workload.

17. The method of claim 16, wherein the workload of the host system is the deterministic workload when a plurality of read requests from the host system are associated with sequential block addresses of the memory device, and wherein the workload of the host system is the random workload when the plurality of read requests from the host system are not associated with the sequential block addresses.

18. The method of claim 16, wherein the identified read operation corresponds to using a ramped input voltage signal for a word line of the memory device when the workload is the deterministic workload, and wherein the identified read operation corresponds to using a constant input voltage for the word line of the memory device when the workload is the random workload.

19. The method of claim 18, wherein the ramped input voltage signal corresponds to an increasing input voltage that is applied to the word line of the memory device.

20. The method of claim 15, wherein the characteristic of the host system is an identification of an application providing the read request from the host system.

21. A system comprising:
a memory device; and
a processing device, operatively coupled with the memory device, to:
receive a plurality of read requests from a host system;
determine whether the plurality of the read requests from the host system corresponds to a deterministic workload or a random workload;
in response determining that the plurality of read requests corresponds to the deterministic workload, identify a first read operation from a plurality of read operations; and
provide the identified first read operation to the memory device to retrieve data stored at a plurality of sequential blocks of the memory device.

22. The system of claim 21, wherein the processing device is further to:
in response determining that the plurality of read requests corresponds to the random workload, identify a second read operation from the plurality of read operations, wherein the second read operation is different than the first read operation; and
provide the identified second read operation to the memory device to retrieve data stored at a block of the memory device that corresponds to one read request from the plurality of read requests.

23. The system of claim 22, wherein the first read operation corresponds to applying a ramped input voltage signal to a word line of the memory device, and wherein the second read operation corresponds to applying a constant input voltage signal to the word line of the memory device.

24. The system of claim 23, wherein the ramped input voltage signal corresponds to an increasing input voltage that is applied to the word line of the memory device.

25. The system of claim 21, wherein to determine whether the plurality of read requests from the hosts system corresponds to the deterministic workload or the random workload, the processing device is further to:
identify whether the plurality of read requests identify sequential block addresses of the memory device, wherein the plurality of read requests are determined to correspond to the deterministic workload when the plurality of read requests identify the sequential block addresses of the memory device, and wherein the plurality of read requests are determined to correspond to the random workload when the plurality of read requests do not identify the sequential block addresses of the memory device.

26. A system comprising:
a memory device; and
a processing device, operatively coupled with the memory device, to:
receive a plurality of read requests from a host system;
identify a workload of the host system based on the plurality of read requests;
determine whether the workload of the host system is deterministic or random;
in response to determining that the workload of the host system is deterministic, indicate for the memory device to retrieve data associated with the plurality of read requests by applying a first voltage signal to an input of the memory device; and
in response to determining that the workload of the host system is random, indicate for the memory device to retrieve the data associated with the plurality of read requests by applying a second voltage signal to the input of the memory device.

27. The system of claim 26, wherein the first voltage signal corresponds to an increasing voltage applied to the input of the memory device, and wherein the second voltage signal corresponds to a constant voltage applied to the input of the memory device.

28. The system of claim 27, wherein the input of the memory device is a word line of the memory device.

29. The system of claim 26, wherein to determine whether the workload of the host system is deterministic or random, the processing device is further to:
determine whether the plurality of read requests are associated with sequential block addresses of the memory device, wherein the workload of the host system is determined to be deterministic when the plurality of read requests are associated with the sequential block addresses of the memory device, and wherein the workload of the host system is determined to be random when the plurality of read requests are not associated with the sequential block addresses.

30. The system of claim 26, wherein data from a plurality of memory pages is retrieved when the first voltage signal is applied to the input of the memory device, and wherein data from a fewer amount of memory pages than the plurality of memory pages is retrieved when the second voltage signal is applied to the input of the memory device.

31. The system of claim 26, wherein applying the first voltage signal to the input of the memory device is associated with applying another voltage signal to a plurality of bit lines of the memory device as a voltage of the first voltage signal is increased.
